(19) United States
(12) Patent Application Publication
(10) Pub. No.: US 2024/0427217 A1
(43) Pub. Date: Dec. 26, 2024

(54) METHOD FOR PREPARING A GOTTESMAN-KITAEV-PRESKILL STATE USING AN ARTIFICIAL-ATOM IN A CAVITY AND APPARATUS THEREOF

(71) Applicants: Sandeep Kumar Goyal, Punjab (IN); Teja G. P., Punjab (IN); Biman Chattopadhyay, Maharashtra, IN (US); Ravi Mehta, Maharashtra (IN)

(72) Inventors: Sandeep Kumar Goyal, Punjab (IN); Teja G. P., Punjab (IN); Biman Chattopadhyay, Maharashtra, IN (US); Ravi Mehta, Maharashtra (IN)

(21) Appl. No.: 18/212,895

(22) Filed: Jun. 22, 2023

(51) Int. Cl. G02F 3/00

(52) U.S. Cl. CPC G02F 3/00

(57) ABSTRACT

Present disclosure relates to method and apparatus for preparing GKP state using artificial atom in cavity. Method comprises utilizing artificial atom in equal superposition state of two low-energy states and reflecting displaced squeezed vacuum state of light off artificial atom in atom-cavity setup. Method comprises performing unitary operation on two low-energy states of artificial atom to convert them in an equal superposition of two low-energy states and displacing a photonic state by interfering the photonic state with a coherent state of light from a beam splitter. Unitary operation and displacement operation are repeated one or more times. Method comprises measuring the artificial atom to produce the photonic state with a plurality of peaks, interfering two identical photonic states, and performing a homodyne measurement to obtain a proto/intermediate-GKP state. Method comprises interfering the proto/intermediate-GKP state with squeezed vacuum state of light and performing homodyne measurement to obtain a desired GKP state.

### TECHNICAL FIELD

The present disclosure relates to a field of quantum computing. Particularly, but not exclusively, the present disclosure relates to a method to prepare Gottesman-Kitaev-Preskill (GKP) state using a general 3-level artificial-atom in a cavity.

### BACKGROUND

Quantum computing is an area of computing focused on developing computer technology based on the principles of quantum theory (which explains the behaviour of energy and material on atomic and subatomic levels). Computers used today can only encode information in bits that take the value of 1 or 0 restricting their ability. Quantum computing, on the other hand, uses quantum bits or qubits. It harnesses the unique ability of subatomic particles that allows them to exist in more than one state (i.e., a 1 and a 0 at the same time).

Quantum computing is a type of computation that harnesses the properties of quantum states, such as superposition, interference, and entanglement to perform calculations. The devices that perform quantum computations or computing are known as quantum computers. Though current quantum computers are too small to outperform usual (classical) computers for practical applications, the quantum computers are believed to be capable of solving certain computational problems, such as integer factorization (which underlies Rivest-Shamir-Adleman (RSA) encryption), substantially faster than classical computers.

Quantum computation offers a promising new kind of information processing, where the non-classical features of quantum mechanics are harnessed and exploited. A number of models of quantum computation exist. These models have been shown to be formally equivalent, but their underlying elementary concepts and the requirements for their practical realization can differ significantly. A particularly exciting paradigm is that of Measurement-Based Quantum Computation (MBQC), where the processing of quantum information takes place by rounds of simple measurements on qubits prepared in a highly entangled state.

In MBQC, a system is first prepared in a highly entangled quantum state, a two-Dimensional (2D)-cluster state, independently of a quantum algorithm that is to be implemented—thus the cluster state is called a ‘universal resource’. In a second step, the qubits in the system are measured individually, in a certain order and basis, and it is this measurement pattern that specifies the entire algorithm. The quantum algorithm thereby corresponds, in an explicit sense, to a processing of quantum correlations.

A MBQC-based quantum computer is equipped with a remarkable feature, namely that the entire resource for the computation is provided by the entangled cluster state in which the system is initialized. This implies that the computational power of such a quantum computer can be traced back entirely to the properties of its entangled resource state, thereby, offering a focused way of thinking about the nature and strength of quantum computation. Moreover, the problem of an experimental realization of a quantum computer is now reduced to the preparation of a specific multi-particle state and the ability to carry out single-qubit measurements, offering practical advantages for certain physical set-ups.

Both discrete and continuous systems can be used to encode quantum information. Most quantum computation schemes propose encoding qubits in two-level systems, such as a two-level atom or an electron spin. Others exploit the use of an infinite-dimensional system, such as a harmonic oscillator. In “Encoding a qubit in an oscillator” [Phys. Rev. A 64 012310 (2001)], Gottesman, Kitaev, and Preskill (GKP) combined these approaches when they proposed a fault-tolerant quantum computation scheme in which a qubit is encoded in the continuous position and momentum degrees of freedom of an oscillator.

The GKP states are coherent superpositions of periodically displaced squeezed vacuum states. Because of the challenge of merely preparing the states, the GKP states were for a long time considered to be impractical. However, the developments in quantum hardware and control technology in the last two decades has made the GKP state/code a frontrunner in the race to build practical, fault-tolerant bosonic quantum technology. There are few methods available for generating GKP states. Some of these methods are explained below:
(1) Gaussian Boson Sampling (GBS) method: This method generates GKP states by passing squeezed vacuum states through an N-mode interferometer network consisting of beam splitters and phase shifters. To generate the GKP state, N−1 modes are measured using Photon Number Resolving (PNR) detectors and conditioned on the PNR outcomes a GKP state is generated in one of modes. The GBS method relies on the PNR detectors, which are expensive and typically operate at few Kelvins temperature. Also, due to low probability, the GBS method requires large number of multiplexing to generate a single GKP state.
(2) Atom-cavity method: In this method, a three-level atom is trapped inside a high finesse optical cavity in a strong coupling regime. Then the atom is prepared in an equal superposition of two degenerate ground states. An optical pulse in a squeezed coherent state is reflected from an atom-cavity setup, which results in a controlled joint operation between the atom-cavity setup and an optical beam, resulting in an entangled final state. The measurement of the atom in initial atomic states yields a Schrodinger cat state of an optical pulse. Repeating the procedure N number of times followed by a displacement result in a GKP state with 2^{N} number of peaks of equal heights. Since N-identical measurement outcomes are required, success probability to generate a GKP state after N-reflections is ½^{N}. This method has an experimental drawback of measuring the atom N-times and any error/loss (ϵ) in measurement will reduce the success of generating the GKP state to (1−ϵ)^{N}. Further, a typical measurement on atom lasts for few microseconds (μs) and the light reflection has to be delayed until the measurement is performed. This process will slow down the process of generating GKP state.
(3) Cat-breeding method: In this method, an approximate GKP state is generated using cat states, linear optical devices, squeezing, and homodyne detection. Procedure is as follows, first, prepare two squeezed cat states (with 2 peaks), interfere them at a 50:50 beam splitter, then perform homodyne detection on one of output ports. Depending on the measurement result, an approximate GKP state (with 3 peaks) is generated. This process can be repeated to generate approximate GKP states with larger number of peaks. This method requires 2N cat states to generate a GKP with (2N+1) peaks. Further, this method has a drawback of low success probabilities, thus, requires a large multiplexing to generate a single GKP state.
(4) Measurement-free method: In this method, a measurement-free preparation protocol is devised using ultra-strong coupling between qubit and a cavity/vibration mode. The method works in three steps: preparation, displacement, and disentanglement. All the three steps rely on controlled gates operations of the form exp[iθ\hat{X}\hat{σ}] with \hat{X} and \hat{σ} begin the bosonic and qubit operators. Such gate operations are possible only in ultra-strong coupling regime and are realized only in microwave cavities and trapped ions. Although this method deterministically generates GKP states, it is limited to microwave regime and requires ultra-strong coupling.

The information disclosed in this background of the disclosure section is for enhancement of understanding of the general background of the invention and should not be taken as an acknowledgement or any form of suggestion that this information forms the prior art already known to a person skilled in the art.

### SUMMARY

In an embodiment, the present disclosure relates to a method for preparing a Gottesman-Kitaev-Preskill (GKP) state using an artificial atom in a cavity. The method comprising producing, by an optical circuit, a displaced squeezed vacuum state of a light using one or more light sources and reflecting, by the optical circuit, the displaced squeezed vacuum state of the light off an artificial atom arranged in an atom-cavity setup, wherein the artificial atom is prepared in an equal superposition state of two low-energy states, resulting in an entangled state of the light and the artificial atom. Thereafter, the method comprising performing, by the optical circuit, unitary operation on the two low-energy states of the artificial atom to convert them in an equal superposition of the two low-energy states and displacing, by the optical circuit, a photonic state by interfering the photonic state with a coherent state of light from a beam splitter. The photonic state is a state of the reflected light from the atom-cavity setup. The unitary operation on the artificial atom to generate the entangled state of light and the artificial atom and displacing the photonic state by interfering the photonic state with the coherent state of light is repeated one or more times. Subsequently, the method comprising measuring, by the optical circuit, the artificial atom to produce the photonic state with a plurality of peaks. Each peak of the plurality of peaks has a positive amplitude or a negative amplitude and equal magnitude. The method comprising interfering, by a balanced beam splitter, two identical photonic states, and performing a homodyne measurement on one of an output of the interfered two identical photonic states from the balanced beam splitter to obtain a proto/intermediate-GKP state with all positive peaks of equal amplitude on other port of the balanced beam splitter. The proto/intermediate GKP state is a photonic state with a plurality of equispaced peaks with equal amplitudes. Further, the method comprising interfering, by the balanced beam splitter, the proto/intermediate-GKP state with a squeezed vacuum state of an appropriate squeezing of the light and performing a homodyne measurement on one of the outcomes of the balanced beam splitter resulting in a desired GKP state at other output of the balanced beam splitter.

In another embodiment, the present disclosure relates to an apparatus for preparing a Gottesman-Kitaev-Preskill (GKP) state using an artificial atom in a cavity. The apparatus comprising an optical circuit configured to produce a displaced squeezed vacuum state of a light using one or more light sources and reflect the displaced squeezed vacuum state of the light off an artificial atom arranged in an atom-cavity setup, wherein the artificial atom is prepared in an equal superposition state of two low-energy states, resulting in an entangled state of the light and the artificial atom. Thereafter, the optical circuit is configured to perform unitary operation on the two low-energy states of the artificial atom to convert them in an equal superposition of the two low-energy states and displace a photonic state by interfering the photonic state with a coherent state of light from a beam splitter. The photonic state is a state of the reflected light from the atom-cavity setup. The unitary operation on the artificial atom to generate the entangled state of light and the artificial atom and displacing the photonic state by interfering the photonic state with the coherent state of light is repeated one or more times. Subsequently, the optical circuit is configured to measure the artificial atom to produce the photonic state with a plurality of peaks. Each peak of the plurality of peaks has a positive amplitude or a negative amplitude and equal magnitude. A balanced beam splitter communicatively coupled to the optical circuit is configured to interfere two identical photonic states and perform a homodyne measurement on one of an output of the interfered two identical photonic states from the balanced beam splitter to obtain a proto/intermediate-GKP state with all positive peaks of equal amplitude on other port of the balanced beam splitter. The proto/intermediate GKP state is a photonic state with a plurality of equispaced peaks with equal amplitudes. Further, the balanced beam splitter is configured to interfere the proto/intermediate-GKP state with a squeezed vacuum state of an appropriate squeezing of the light and perform a homodyne measurement on one of the outcomes of the balanced beam splitter resulting in a desired GKP state at other output of the balanced beam splitter.

Embodiments of the disclosure according to the above-mentioned method, and the apparatus bring about following technical advantages.

The present disclosure uses atom-cavity setup that requires only a single measurement on an artificial atom and does not require N number or multiple number of measurements. Instead, the method of the present disclosure applies a unitary transformation on the artificial atom and prepares the artificial atom in an equal superposition of the two low energy states. As a result, the method of the present disclosure requires only one measurement at the end of the method/protocol for preparing a GKP state. Consequently, the method of the present disclosure is experimentally simple.

The probability to generate GKP state with N-peaks (N is a finite number) in the present disclosure reduces to ½^{N} but any error (ϵ) in measurement does not scale with N.

The atom-cavity setup of the present disclosure uses linear optical components such as balanced beam splitter and homodyne measurement apparatus in a configuration that converts proto/intermediate-GKP state to a desire GKP state. Typically, the proto/intermediate-GKP state is not useful GKP state, hence, is discarded. Whereas the method of the present disclosure makes use of this proto/intermediate-GKP state by converting this state to a desired GKP state, resulting in improving the probability of success to obtain the desired GKP state.

The total efficiency of the method of the present disclosure can be defined as η_{T}=p_{c}p_{g}(ηₐ)²(ηₕₒₘ)² where p_{c} and p_{g} are the success probabilities for the amplitude correction and multiplying the Gaussian amplitudes, respectively. ηₐ and ηₕₒₘ are the efficiencies of atom-cavity setup measurement and homodyne measurement, respectively.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and together with the description, serve to explain the disclosed principles. In the figures, the left most digit(s) of a reference number identifies the figure in which the reference number first appears. The same numbers are used throughout the figures to reference like features and components. Some embodiments of system and/or methods in accordance with embodiments of the present subject matter are now described below, by way of example only, and with reference to the accompanying figures.

FIG. 1a shows a measurement outcome of an optical circuit.

FIGS. 1b-1c illustrate an exemplary apparatus for preparing a GKP state using an artificial atom in a cavity in accordance with some embodiments of the present disclosure.

FIG. 1d shows a probability density (p_{g}) for the homodyne measurement outcomes as a function of squeezing in accordance with some embodiments of the present disclosure.

FIG. 1e shows fidelity (F) for various homodyne measurement outcomes |x=a [symbol] and different squeezing values in decibels (dB).

FIG. 2 illustrates a flowchart showing a method for preparing a Gottesman-Kitaev-Preskill (GKP) state using an artificial atom in a cavity in accordance with some embodiments of present disclosure.

It should be appreciated by those skilled in the art that any block diagrams herein represent conceptual views of illustrative systems embodying the principles of the present subject matter. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

In an atom-cavity setup, conventionally a GKP state is generated using N atom-cavity reflections where each reflection is followed by a measurement and reinitialization of the atom in the atom-cavity setup. These multiple measurements (i.e., measuring the atom N-times) in the atom-cavity setup can be experimentally challenging. Further, any error/loss (ϵ) in measurement reduces the success of generating the GKP state to (1−ϵ)^{N} (N refers to measuring the atom N-times). Also, a typical measurement on atom lasts for few microseconds (μs) and the reflection of the light from the atom-cavity setup has to be delayed until the measurement is performed. This process slows down the process of generating GKP state. In the present disclosure, to overcome the above-mentioned drawback of multiple measurements on the atom, a displaced squeezed vacuum state of the light is reflected off the atom (also, referred as an artificial atom) arranged in the atom-cavity setup multiple times without any measurements between successive reflections and a single measurement is performed after multiple reflections (i.e., N-times). This method generates a photonic state with a plurality of peaks, wherein each peak of the plurality of peaks has a positive amplitude or a negative amplitude. This state may be referred as a prototype-GKP state with finite peaks and unequal amplitudes. The unequal amplitudes (i.e., negative amplitudes) are corrected using two identical photonic states (i.e., prototype GKP states), a balanced Beam Splitter (BS) and a homodyne measurement circuit to obtain a proto/intermediate-GKP state with all positive peaks of equal amplitude. The proto/intermediate GKP state is a photonic state with a plurality of equispaced peaks with equal amplitudes. Finally, the proto/intermediate-GKP state with finite peaks and equal amplitude is interfered with a squeezed vacuum state of an appropriate squeezing of the light at the balanced BS and measured using the homodyne measurement circuit to obtain a desired GKP state with a Gaussian envelope. Squeezed states are photonic states which have Gaussian shape in quadrature space. For various tasks, Gaussian states of a particular width and mean value are required. The width of the Gaussian defines the level/amount/magnitude of squeezing. Hence, according to a given task, an appropriate squeezed state needs to be chosen. An appropriate squeezing of light refers to squeezing of photonic states to obtain an appropriate width of a Gaussian shape.

An ideal GKP states are defined as simultaneous eigenstates of displacement operator S_{q}=exp{i2\sqrt{π}X} and S_{q}=exp{i2\sqrt{π}P} where

$$X = \frac{1}{\sqrt{2}} ( \hat{a} + {\hat{a}}^{†} ) , P = \frac{1}{\sqrt{2 i}} ( \hat{a} - {\hat{a}}^{†} ) and [ X , P ] = i .$$

The ideal GKP states are written as

$$\vert 0 〉 = {\sum }_{n} \vert x = 2 n \sqrt{π} 〉 , \qquad ( 1 a )$$

$$\vert 1 〉 = {\sum }_{n} \vert x = ( 2 n + 1 ) \sqrt{π} 〉 , \qquad ( 1 b )$$

In the X-quadrature space, the equations (1a) and (1b) represent Dirac-deltas with a spacing of 2\sqrt{π}. The equation (1a) and equation (1b) may be collectively referred as equation (1). The Dirac-deltas represent infinite squeezing in peaks and are unphysical. The physical or desired GKP states are obtained by replacing the infinitely squeezed peaks with finite squeezing. The GKP states with finite spacing are approximated as

$${ψ}_{0} ( x ) = {N}_{0} {\sum }_{n = - ∞}^{∞} {e}^{- \frac{{( Δ2 n \sqrt{π} )}^{2}}{2}} {e}^{- \frac{{( x - 2 n \sqrt{π} )}^{2}}{2 {Δ}^{2}}} \qquad ( 2 )$$

$${ψ}_{1} ( x ) = {N}_{1} {\sum }_{n = - ∞}^{∞} {e}^{- \frac{{( Δ ( 2 n + 1 ) \sqrt{π} )}^{2}}{2}} {e}^{- \frac{{( x - ( 2 n + 1 ) \sqrt{π} )}^{2}}{2 {Δ}^{2}}} \qquad ( 3 )$$

where N_{0,1} are normalization constants.

An apparatus for preparing a GKP state comprises an optical circuit and an atom-cavity setup. The optical circuit comprises one or more components (also, referred as optical elements) such as one or more light sources, one or more beam splitters, a laser source, a nonlinear crystal, and one or more mirrors. The one or more components are arranged such that the optical circuit produces a displaced squeezed vacuum state of a light using the one or more light sources. In detail, initially the optical circuit produces a squeezed vacuum state of the light from the one or more light sources using the nonlinear crystal. Thereafter, the optical circuit displaces the squeezed vacuum state of the light using an (intense) laser beam/pulse from laser source and the one or more beam splitters to obtain displaced squeezed vacuum state of a light. In one embodiment, micro-ring resonators is used instead of the nonlinear crystal. Each of the one or more light sources is a light source that produces a squeezed light. The squeezed light refers to a state of light with a reduced quantum uncertainty in its electric field strength for some phases compared to a coherent state. The one or more light sources is a coherent light source. The coherent state of light is a laser pulse.

The optical circuit focusses the displaced squeezed vacuum state of the light on an artificial atom arranged in the atom-cavity setup such that the displaced squeezed vacuum state of the light interacts with the artificial atom. The atom-cavity setup can be in general any atom-cavity setup known conventionally in the art. The atom-cavity setup consists of an artificial atom trapped inside a cavity. In one embodiment, the cavity is a free space cavity such as Fabry-Perrot cavity. The artificial atom is a 3-level artificial atom, which refers to a system with a certain energy band structure. The artificial atom (i.e., 3-level artificial atom) contains three energy levels with two of the three energy levels are closely spaced lower energy level states and one of the three energy levels is an excited state. This desired three energy levels may be referred as a lambda configuration. The artificial atom is one of, but not limited to, a quantum dot, a trapped ion, a defect centre in a diamond, or a real atom of any element such as Rubidium (Rb), Calcium (Ca), Caesium (Cs), and the like that exhibits the lambda configuration. The transitions between the three energy levels are such that the transitions are only allowed between the excited state and the two lower energy states. The cavity is chosen in such a way that the cavity interacts with only one of the transitions. For instance, the atomic transition |0 [symbol] ↔|1 [symbol] is in resonance with a cavity mode â. And the transition |0 [symbol] ↔|−1 [symbol] is decoupled from the cavity. When the displaced squeezed vacuum state of the light resonant with the |0 [symbol] ↔|1 [symbol] transition interacts with atom-cavity setup, the reflection coefficient r is written as

$$r = \frac{- κγ / 4 + {g}^{2}}{κγ / 4 + {g}^{2}} \qquad ( 4 )$$

where g is the atom-cavity coupling strength. κ and γ are decay rates of the cavity and the atom. Further g²>>κγ gives r=1 for the transition |0 [symbol] ↔|1 [symbol] . Since the transition |0 [symbol] ↔|−1 [symbol] is decoupled (g=0) atom-cavity setup gives r=−1.

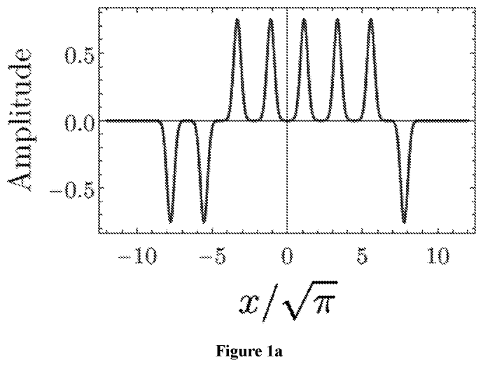

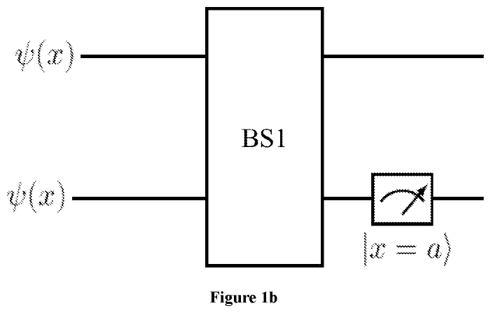

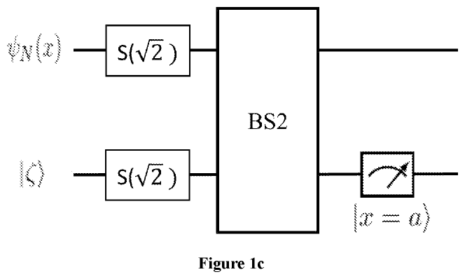

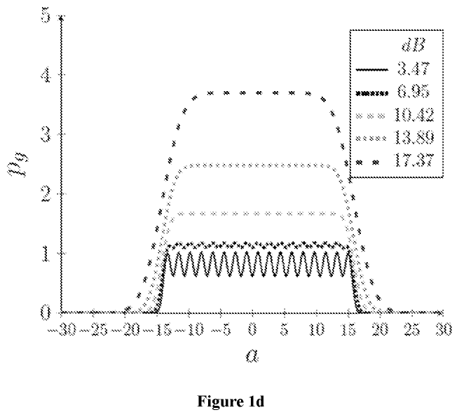

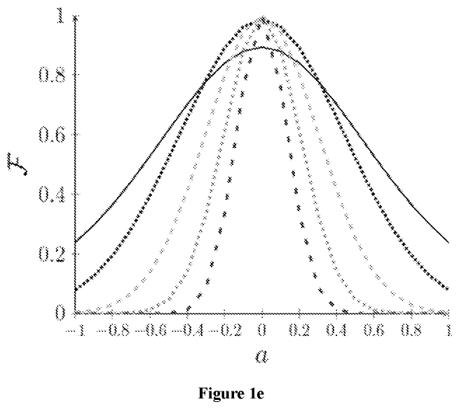

Initially, the artificial atom is prepared in an equal superposition state of two low-energy states. Thereafter, the optical circuit reflects the displaced squeezed vacuum state of the light off the artificial atom arranged in the atom-cavity setup. This results in an entangled state of the light (i.e., the displaced squeezed vacuum state of the light) and the artificial atom. The optical circuit performs a unitary operation on the two low-energy states of the artificial atom to convert them in an equal superposition of the two low-energy states. Subsequently, the optical circuit displaces a photonic state by interfering the photonic state with a coherent state of light from a beam splitter (of the one or more beam splitters). Here, the photonic state is a state of the reflected light from the atom-cavity setup. The process of unitary operation on the artificial atom to generate the entangled state of light and the artificial atom and displacing the photonic state by interfering the photonic state with the coherent state of light is repeated one or more times. At this stage, the optical circuit measures the artificial atom to produce the photonic state with a plurality of peaks. Each peak of the plurality of peaks has a positive amplitude or a negative amplitude and equal magnitude as shown in the FIG. 1a. In detail, the Figure la shows the photonic state (also, referred as a prototype-GKP state with finite peaks and unequal amplitudes) generated after three reflections from the atom-cavity setup and projecting artificial atom in the state |−1 [symbol] . For instance, on preparing the artificial atom in

$$\vert + 〉 = \frac{1}{\sqrt{2}} \vert - 1 〉 + \vert 1 〉$$

and the light mode in squeezed coherent states (i.e., the displaced squeezed vacuum state of the light) of the form |α₁, ζ [symbol] =D(α₁)Ŝ(ζ)|0 [symbol] results in

$$\vert ψ 〉 = \vert - {α}_{1} , ζ 〉 \vert - 1 〉 + \vert {α}_{1} , ζ 〉 \vert 1 〉 \qquad ( 5 )$$

where α₁ and ζ are the displacement and squeezing parameters. Measuring the artificial atom in |+ [symbol] state result in the squeezed cat states (SQC)

$${\vert sqc 〉}_{1} = \vert - {α}_{1} , ζ 〉 + \vert {α}_{1} , ζ 〉 \qquad ( 6 )$$

In a X-quadrature space, each term in |sqc [symbol] ₁ represent a squeezed peaks (also, referred as Gaussian peaks) separated by a distance of 2Re{α₁}.

In an embodiment, the general state of an optical mode (i.e., photonic state) after N reflections and measurement can be written as

$${\vert sqc 〉}_{N} = {\sum }_{j = 1}^{N} \vert - {α}_{j} , ζ 〉 + \vert {α}_{j} , ζ 〉 \qquad ( 8 )$$

where N is the normalization constant. Re{αⱼ} and |ζ| give the spacing and width of the peaks. Also, the state |sqc [symbol] _{N} in the quadrature state is written as

$$ψ ( x ) = 〈 x \vert {sqc}_{N} 〉 = \frac{{N}_{0}}{\sqrt{{2}^{N}}} {\sum }_{n = - l}^{l} {e}^{- \frac{{( x - ( 2 n + 1 ) \sqrt{π} )}^{2}}{2 {Δ}^{2}}} \qquad ( 9 )$$

where

$${N}_{0} = {( \frac{1}{\sqrt{π} Δ} )}^{1 / 2}$$

is the normalization constant and Δ=e^{-ξ}. Similarly, the state of the optical mode (i.e., photonic state) after N reflections, displacements, and a single measurement is written as

$$\overline{ψ} ( x ) = 〈 x \vert {\overline{sqc}}_{N} 〉 = \frac{{N}_{0}}{\sqrt{{2}^{N}}} {\sum }_{n = - N}^{N} {c}_{n} {e}^{- \frac{{( x - ( 2 n + 1 ) \sqrt{π} )}^{2}}{2 {Δ}^{2}}} \qquad ( 10 )$$

where |s̅q̅c̅_{N} [symbol] denotes the state without measurements and cₙ∈{1, −1}. Hence, evading the measurements resulted in flipping the amplitude of few peaks of the optical state (i.e., photonic state) as shown in the FIG. 1a.

The output of the optical circuit is transmitted to a balanced beam splitter, which is communicatively coupled to the optical circuit. The balanced beam splitter interferes two identical photonic states. Thereafter, a homodyne measurement circuit communicatively coupled to the balanced beam splitter performs a homodyne measurement on one of an output of the interfered two identical photonic states received from the balanced beam splitter to obtain a proto/intermediate-GKP state (also, referred as corrected GKP-state) with all positive peaks of equal amplitude on other port of the balanced beam splitter. The proto/intermediate GKP state is a photonic state with a plurality of equispaced peaks with equal amplitudes. For instance, in order to convert the proto/intermediate-GKP state, using equation (10) into a desired GKP state, the amplitudes have cₙ to be flipped and a Gaussian profile is required for the amplitudes of the peaks. The flipping and the Gaussian profile can be achieved by using a 50:50 BS (i.e., a balanced BS) and a homodyne measurement. To correct the amplitudes of the peaks, two identical ψ(x) states (i.e., photonic states) are mixed at the BS and then a homodyne measurement in the second mode flips the amplitudes as shown in the FIG. 1b. The initial state of the system is written as

$$ψ ( {x}_{1} , {x}_{2} ) = ψ ( {x}_{1} ) ψ ( {x}_{2} ) \qquad ( 11 )$$

$$= \frac{{{N}_{0}}^{2}}{{2}^{N}} {\sum }_{n} {c}_{n} {c}_{m} f [ {x}_{1} - ( 2 n + 1 ) \sqrt{π} ] f [ {x}_{2} - ( 2 m + 1 ) \sqrt{π} ] \qquad ( 12 )$$

where the amplitudes (c_{n,m}) can be +1 or −1 and

$$f ( x ) = {e}^{\frac{- {x}^{2}}{2 {Δ}^{2}}}$$

with Full Width at Half Maximum (FWHM) ω=2\sqrt{2ln2}Δ. Then the balanced BS transforms the quadrature as

$${x}_{1} \to \frac{{x}_{1} + {x}_{2}}{\sqrt{2}} , {x}_{2} \to \frac{{x}_{1} - {x}_{2}}{\sqrt{2}} \qquad ( 13 )$$

to give

$$ψ ( {x}_{1} , {x}_{2} ) \to ψ ( \frac{{x}_{1} + {x}_{2}}{\sqrt{2}} , \frac{{x}_{1} - {x}_{2}}{\sqrt{2}} ) \qquad ( 14 )$$

The un-normalized state after the homodyne measurement |x₂=a [symbol] is written as

$${ψ}_{M} ( {x}_{1} ) = \int δ ( {x}_{2} - a ) ψ ( \frac{{x}_{1} + {x}_{2}}{\sqrt{2}} , \frac{{x}_{1} - {x}_{2}}{\sqrt{2}} ) {dx}_{2} = ψ ( \frac{{x}_{1} + a}{\sqrt{2}} , \frac{{x}_{1} - a}{\sqrt{2}} ) \qquad ( 15 )$$

where the probability density for ‘a’ is obtained as

$$p ( a ) = \int {\vert ψ ( \frac{{x}_{1} + a}{\sqrt{2}} , \frac{{x}_{1} - a}{\sqrt{2}} ) \vert}^{2} {dx}_{1} \qquad ( 16 )$$

On using equation (11) in equation (15), the un-normalized state yields

$$ψ ( {x}_{1} , {x}_{2} ) = \frac{{{N}_{0}}^{2}}{{2}^{N}} {\sum }_{n} {c}_{n} {c}_{m} h [ {x}_{1} + a - ( 2 n + 1 ) \sqrt{2 π} ] h [ {x}_{1} - a - ( 2 m + 1 ) \sqrt{2 π} ] \qquad ( 17 )$$

where

$$h ( x ) = {e}^{- \frac{{x}^{2}}{2 {( \sqrt{2} Δ )}^{2}}} .$$

Assuming that the measurement outcome is less than FWHM i.e., |a|<4\sqrt{ln2}Δ<2\sqrt{2π}. Equation (17) simplifies to

$${ψ}_{M} ( {x}_{1} ) = {e}^{\frac{- {a}^{2}}{2 {Δ}^{2}}} \frac{{{N}_{0}}^{2}}{{2}^{N}} {\sum }_{n} {{c}_{n}}^{2} f [ {x}_{1} - ( 2 n + 1 ) \sqrt{π} ] \qquad ( 18 )$$

Since cₙ²=1, the amplitudes of equation (18) are corrected. Then on using equation (16), the probability to obtain the value ‘a’ is obtained as

$$p ( z ) = \frac{1}{{2}^{N}} \frac{1}{\sqrt{π} Δ} {\int }_{- z}^{z} {e}^{- {a}^{2} / {Δ}^{2}} da \qquad ( 19 )$$

then z={ω̅/4, ω̅/3, ω̅/2} gives p(z)=½^{N}{0.594, 0.733,0.904}. Since two identical states (i.e., photonic states) are required, p(z) is further reduced to p(z)=½^{N}0.5{0.594, 0.733, 0.904}. Note that p(z) is independent of the squeezing parameter (ζ). Also, the measurement outcome does not show-up in the corrected state, hence larger values of z˜ω̅/2 will not change the shape of the state (i.e., photonic state) and the total success probability is given by p(z)=½^{{N+1}}. The normalized state after the homodyne measurement is

$${ψ}_{N} ( x ) = \frac{1}{\sqrt{{2}^{N}}} {( \frac{1}{\sqrt{π} Δ} )}^{1 / 2} {\sum }_{n} exp [ \frac{( x - ( 2 n + 1 ) {\sqrt{π )}}^{2}}{2 {Δ}^{2}} ] \qquad ( 20 )$$

To obtain a desired GKP state from the proto/intermediate-GKP state, the balanced beam splitter interferes the proto/intermediate-GKP state with a squeezed vacuum state of an appropriate squeezing of the light. Squeezed states are photonic states which have Gaussian shape in quadrature space. For various tasks, Gaussian states of a particular width and mean value are required. The width of the Gaussian defines the level/amount/magnitude of squeezing. Hence, according to a given task, an appropriate squeezed state needs to be chosen. An appropriate squeezing of light refers to squeezing of photonic states to obtain an appropriate width of a Gaussian shape. Finally, the homodyne measurement circuit performs a homodyne measurement on one of the outcomes of the balanced beam splitter resulting in a GKP state (also, referred as desired GKP state or final GKP state) at other output of the balanced beam splitter. For instance, to obtain the GKP state, the proto/intermediate-GKP state is squeezed and entangled it with squeezed vacuum at a 50:50 BS. Then a homodyne measurement is performed in the second mode to give the Gaussian profile. The state before the BS is written as

$$ψ ( {x}_{1} , {x}_{2} ) = {ψ}_{M} ( {x}_{1} ) ϕ ( {x}_{2} ) \qquad ( 21 )$$

where

$$ψ ( {x}_{2} ) = {( \frac{1}{\sqrt{π} σ} )}^{1 / 2} {e}^{- {x}_{2}^{2} / 2 {σ}^{2}}$$

with σ=1/Δ is the envelop required for the GKP state. On applying a squeezing of the form x→\sqrt{2}x gives

$$ψ ( {x}_{1} ) = ψ ( \sqrt{2} {x}_{1} , \sqrt{2} {x}_{2} ) \qquad ( 22 )$$

On using equation (15) the state after BS and homodyne measurement (|x=a [symbol] ) is written as

$$ψ ( {x}_{1} ) = {ψ}_{N} ( {x}_{1} + a ) ϕ ( {x}_{2} - a ) \qquad ( 23 )$$

On using the Gaussian form of ψ_{N}(x) in equation (20) and ϕ(x) in equation (23) yields the un-normalized state as

$${ψ}_{g} ( {x}_{1} ) = C {\sum }_{n} {e}^{\frac{- {( 2 a - \sqrt{π} ( 2 n + 1 ) )}^{2}}{2 {\overline{Δ}}^{2}}} exp [ \frac{x - {μ}_{n}}{2 {\overline{σ}}^{2}} ] \qquad ( 24 )$$

$$where$$

$$C = \frac{1}{\sqrt{{2}^{N}}} \sqrt{( \frac{1}{\sqrt{π} Δ} ) ( \frac{1}{\sqrt{π} σ} )}$$

$${μ}_{n} = a + \frac{- 2 a + \sqrt{π} ( 2 n + 1 )}{1 + {Δ}^{4}}$$

$$\overline{Δ} = \sqrt{{Δ}^{2} + \frac{1}{{Δ}^{2}}}$$

$$and$$

$$\overline{σ} = \frac{1}{\sqrt{1 / {Δ}^{2} + {Δ}^{2}}}$$

Note that Δ̅σ̅=1 and since Δ⁴<<1, μₙ=−a+\sqrt{π}(2n+1).

Assuming that the peaks are well separated the probability of ‘a’ outcome is given as

$${p}_{g} ( a ) = ( \frac{1}{{2}^{N} \sqrt{π} Δ} ) \frac{\overline{σ}}{σ} {\sum }_{n} {e}^{- \frac{{( 2 a - \sqrt{π} ( 2 n + 1 ) )}^{2}}{{\overline{Δ}}^{2}}} \qquad ( 25 )$$

and the probability to obtain the value ‘a’ is obtained as

$$p ( z ) = {\int }_{- z}^{z} {p}_{g} ( a ) da \qquad ( 26 )$$

The ideal GKP state is obtained for |x=0 [symbol] and in general the probability depends on ‘z’ and the squeezing parameter ‘r’.

FIG. 1d shows a probability density (p_{g}) for the homodyne measurement outcomes as a function of squeezing. dB is the squeezing in decibels and is defined as −10logΔ². The width is defined as ω̅=2\sqrt{2ln2}Δ. As seen in the FIG. 1d, the success probability of obtaining the GKP state is higher for large intervals of homodyne outcomes.

After multiplying the proto/intermediate GKP state with a Gaussian envelope an approximate GKP state is generated. To understand the quality of the GKP, the fidelity of the approximate GKP state with ideal state is calculated. First, the peaks are shifted by applying a displacement operation

$$\begin{matrix}{ψ}_{d} ( {x}_{1} ) = D ( a ) ψ ( {x}_{1} ) \\ = {ψ}_{N} ( {x}_{1} + 2 a ) ϕ ( {x}_{1} )\end{matrix} \qquad ( 27 )$$

and rewriting a=2\sqrt{π}m±ε or a=m\sqrt{π}±ε, where m is an integer and ε≤\sqrt{π}/2.

Assuming few peaks under the Gaussian envelop than total number of peaks i.e., 1/(2Δ\sqrt{π})<<2^{N} yields

$${ψ}_{d} ( {x}_{1} ) = {ψ}_{N} ( {x}_{1} + ε ) ϕ ( {x}_{1} ) = {\sum }_{n} {exp}^{[ - \frac{{( ε - \sqrt{π} ( 2 n + 1 ) )}^{2}}{2 {\overline{Δ}}^{2}} ]} {exp}^{[ - \frac{{( x - {μ}_{d} )}^{2}}{2 {\overline{σ}}^{2}} ]} \qquad ( 28 )$$

$$where$$

$${μ}_{d} = \frac{ε + \sqrt{π} ( 2 n + 1 )}{1 + {Δ}^{4}}$$

FIG. 1e shows fidelity (F) for various homodyne measurement outcomes |x=a [symbol] and different squeezing values in decibels (dB). In FIG. 1e, it can be seen that the fidelity of GKP state reaches unity for higher values of squeezing. This is because higher squeezing (Δ⁴<<1) gives peak widths (Δ̅=Δ) identical to original GKP state. But the mean is shifted by μ_{d}=ε+\sqrt{π}(2n+1) hence give low fidelities for higher homodyne measurement outcomes.

The total efficiency of the method of the present disclosure can be defined as η_{T}=p_{c}p_{g}(ηₐ)²(ηₕₒₘ)² where p_{c} and p_{g} are the success probabilities for the amplitude correction and multiplying the Gaussian amplitudes, respectively. ηₐ and ηₕₒₘ are the efficiencies of atom-cavity setup measurement and homodyne measurement, respectively.

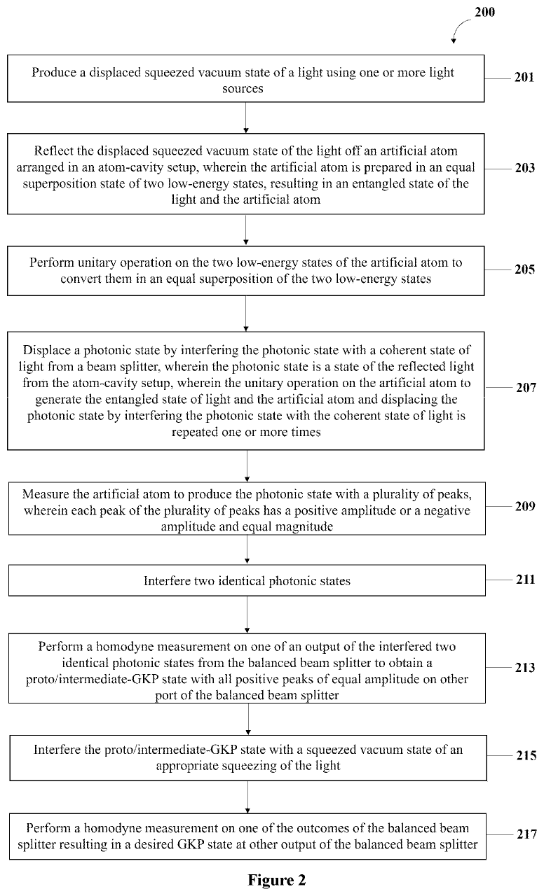

FIG. 2 illustrates a flowchart showing a method for preparing a Gottesman-Kitaev-Preskill (GKP) state using an artificial atom in a cavity in accordance with some embodiments of present disclosure.

As illustrated in FIG. 2, the method 200 includes one or more blocks for preparing a GKP state using an artificial atom in a cavity. The method 200 may be described in the general context of computer executable instructions. Generally, computer executable instructions can include routines, programs, objects, components, data structures, procedures, modules, and functions, which perform particular functions or implement particular abstract data types.

The order in which the method 200 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 201, the optical circuit produces a displaced squeezed vacuum state of a light using one or more light sources. The one or more light sources is a coherent light source. The coherent state of light is a laser pulse. Each of the one or more light sources is a light source that produces a squeezed light. The squeezed light refers to a state of light with a reduced quantum uncertainty in its electric field strength for some phases compared to a coherent state. The optical circuit comprises the one or more light sources, one or more beam splitters, a laser source, a nonlinear crystal, and one or more mirrors.

At block 203, the optical circuit reflects the displaced squeezed vacuum state of the light off an artificial atom arranged in an atom-cavity setup, resulting in an entangled state of the light and the artificial atom. The artificial atom is prepared in an equal superposition state of two low-energy states. The artificial atom is a 3-level artificial atom. The artificial atom contains three energy levels with two of the three energy levels are closely spaced lower energy level states and one of the three energy levels is an excited state. The artificial atom is one of a quantum dot, a trapped ion, and a defect centre in a diamond. The atom-cavity setup is set up such that the atom-cavity setup allows the displaced squeezed vacuum state of the light to interact only with one of transitions of the artificial atom from an excited state to a lower energy level state.

At block 205, the optical circuit performs unitary operation on the two low-energy states of the artificial atom to convert them in an equal superposition of the two low-energy states.

At block 207, the optical circuit displaces a photonic state by interfering the photonic state with a coherent state of light from a beam splitter. The photonic state is a state of the reflected light from the atom-cavity setup. The one or more beam splitter of the optical circuit used for displacing the photonic state has a high transmission coefficient and a low reflection coefficient. An amount of displacement of the photonic state is proportional to a product of amplitude of the coherent state of light and a reflection coefficient of the beam splitter. The unitary operation on the artificial atom to generate the entangled state of light and the artificial atom and displacing the photonic state by interfering the photonic state with the coherent state of light is repeated one or more times.

At block 209, the optical circuit measures the artificial atom to produce the photonic state with a plurality of peaks. Each peak of the plurality of peaks has a positive amplitude or a negative amplitude and equal magnitude.

At block 211, the balanced beam splitter interferes two identical photonic states.

At block 213, the homodyne measurement circuit performs a homodyne measurement on one of an output of the interfered two identical photonic states from the balanced beam splitter to obtain a proto/intermediate-GKP state with all positive peaks of equal amplitude on other port of the balanced beam splitter. The proto/intermediate GKP state is a photonic state with a plurality of equispaced peaks with equal amplitudes.

At block 215, the balanced beam splitter interferes the proto/intermediate-GKP state with a squeezed vacuum state of an appropriate squeezing of the light.

At block 217, the homodyne measurement circuit performs a homodyne measurement on one of the outcomes of the balanced beam splitter resulting in a desired GKP state at other output of the balanced beam splitter.

Some of the technical advantages of the present disclosure are listed below.

The present disclosure uses atom-cavity setup that requires only a single measurement on an artificial atom and does not require N number or multiple number of measurements. Instead, the method of the present disclosure applies a unitary transformation on the artificial atom and prepares the artificial atom in an equal superposition of the two low energy states. As a result, the method of the present disclosure requires only one measurement at the end of the method/protocol for preparing a GKP state. Consequently, the method of the present disclosure is experimentally simple.

The probability to generate GKP state with N-peaks (N is a finite number) in the present disclosure reduces to ½^{N} but any error (ϵ) in measurement does not scale with N.

The atom-cavity setup of the present disclosure uses linear optical components such as balanced beam splitter and homodyne measurement circuit in a configuration that converts proto/intermediate-GKP state to a desire GKP state. Typically, the proto/intermediate-GKP state is not useful GKP state, hence, is discarded. Whereas the method of the present disclosure makes use of this proto/intermediate-GKP state by converting this state to a desired GKP state, resulting in improving the probability of success to obtain the desired GKP state.

The total efficiency of the method of the present disclosure can be defined as η_{T}=p_{c}p_{g}(ηₐ)²(ηₕₒₘ)² where p_{c} and p_{g} are the success probabilities for the amplitude correction and multiplying the Gaussian amplitudes, respectively. ηₐ and ηₕₒₘ are the efficiencies of atom-cavity setup measurement and homodyne measurement, respectively.

We claim:

1. A method for preparing a Gottesman-Kitaev-Preskill (GKP) state using an artificial atom in a cavity, the method comprising:
producing, by an optical circuit, a displaced squeezed vacuum state of a light using one or more light sources;
reflecting, by the optical circuit, the displaced squeezed vacuum state of the light off an artificial atom arranged in an atom-cavity setup, wherein the artificial atom is prepared in an equal superposition state of two low-energy states, resulting in an entangled state of the light and the artificial atom;
performing, by the optical circuit, unitary operation on the two low-energy states of the artificial atom to convert them in an equal superposition of the two low-energy states;
displacing, by the optical circuit, a photonic state by interfering the photonic state with a coherent state of light from a beam splitter,
wherein the photonic state is a state of the reflected light from the atom-cavity setup,
wherein the unitary operation on the artificial atom to generate the entangled state of light and the artificial atom and displacing the photonic state by interfering the photonic state with the coherent state of light is repeated one or more times,
measuring, by the optical circuit, the artificial atom to produce the photonic state with a plurality of peaks, wherein each peak of the plurality of peaks has a positive amplitude or a negative amplitude and equal magnitude;
interfering, by a balanced beam splitter, two identical photonic states; and
performing, by a homodyne measurement circuit, a homodyne measurement on one of an output of the interfered two identical photonic states from the balanced beam splitter to obtain a proto/intermediate-GKP state with all positive peaks of equal amplitude on other port of the balanced beam splitter,
wherein the proto/intermediate GKP state is a photonic state with a plurality of equispaced peaks with equal amplitudes.

2. The method as claimed in claim 1, further comprising:
interfering, by the balanced beam splitter, the proto/intermediate-GKP state with a squeezed vacuum state of an appropriate squeezing of the light; and
performing, by the homodyne measurement circuit, a homodyne measurement on one of the outcomes of the balanced beam splitter resulting in a desired GKP state at other output of the balanced beam splitter.

3. The method as claimed in claim 1, wherein the artificial atom is a 3-level artificial atom, and
wherein the artificial atom contains three energy levels with two of the three energy levels are closely spaced lower energy level states and one of the three energy levels is an excited state.

4. The method as claimed in claim 1, wherein the artificial atom is one of a quantum dot, a trapped ion, and a defect centre in a diamond.

5. The method as claimed in claim 1, wherein each of the one or more light sources is a light source that produces a squeezed light, and
wherein the one or more light sources is a coherent light source.

6. The method as claimed in claim 5, wherein the squeezed light refers to a state of light with a reduced quantum uncertainty in its electric field strength for some phases compared to a coherent state.

7. The method as claimed in claim 1, wherein the atom-cavity setup is set up such that the atom-cavity setup allows the displaced squeezed vacuum state of the light to interact only with one of transitions of the artificial atom from an excited state to a lower energy level state.

8. The method as claimed in claim 1, wherein the coherent state of light is a laser pulse.

9. The method as claimed in claim 1, wherein the beam splitter used for displacing the photonic state has a high transmission coefficient and a low reflection coefficient.

10. The method as claimed in claim 1, wherein an amount of displacement of the photonic state is proportional to a product of amplitude of the coherent state of light and a reflection coefficient of the beam splitter.

11. An apparatus for preparing a Gottesman-Kitaev-Preskill (GKP) state using an artificial atom in a cavity, the apparatus comprising:
an optical circuit configured to:
produce a displaced squeezed vacuum state of a light using one or more light sources;
reflect the displaced squeezed vacuum state of the light off an artificial atom arranged in an atom-cavity setup, wherein the artificial atom is prepared in an equal superposition state of two low-energy states, resulting in an entangled state of the light and the artificial atom;
perform unitary operation on the two low-energy states of the artificial atom to convert them in an equal superposition of the two low-energy states;
displace a photonic state by interfering the photonic state with a coherent state of light from a beam splitter,
wherein the photonic state is a state of the reflected light from the atom-cavity setup,
wherein the unitary operation on the artificial atom to generate the entangled state of light and the artificial atom and displacing the photonic state by interfering the photonic state with the coherent state of light is repeated one or more times,
measure the artificial atom to produce the photonic state with a plurality of peaks, wherein each peak of the plurality of peaks has a positive amplitude or a negative amplitude and equal magnitude;
a balanced beam splitter communicatively coupled to the optical circuit, the balanced beam splitter configured to:
interfere two identical photonic states; and
a homodyne measurement circuit communicatively coupled to the balanced beam splitter, the homodyne measurement circuit is configured to:
perform a homodyne measurement on one of an output of the interfered two identical photonic states from the balanced beam splitter to obtain a proto/intermediate-GKP state with all positive peaks of equal amplitude on other port of the balanced beam splitter,
wherein the proto/intermediate GKP state is a photonic state with a plurality of equispaced peaks with equal amplitudes.

12. The apparatus as claimed in claim 11, the balanced beam splitter is further configured to:
interfere the proto/intermediate-GKP state with a squeezed vacuum state of an appropriate squeezing of the light; and
the homodyne measurement circuit is further configured to:
perform a homodyne measurement on one of the outcomes of the balanced beam splitter resulting in a desired GKP state at other output of the balanced beam splitter.

13. The apparatus as claimed in claim 11, wherein the artificial atom is a 3-level artificial atom,
wherein the artificial atom contains three energy levels with two of the three energy levels are closely spaced lower energy level states and one of the three energy levels is an excited state, and
wherein the artificial atom is one of a quantum dot, a trapped ion, and a defect centre in a diamond.

14. The apparatus as claimed in claim 11, wherein the optical circuit comprises the one or more light sources, one or more beam splitters, a laser source, a nonlinear crystal, and one or more mirrors.

15. The apparatus as claimed in claim 11, wherein each of the one or more light sources is a light source that produces a squeezed light, and
wherein the one or more light sources is a coherent light source.

16. The apparatus as claimed in claim 15, wherein the squeezed light refers to a state of light with a reduced quantum uncertainty in its electric field strength for some phases compared to a coherent state.

17. The apparatus as claimed in claim 11, wherein the atom-cavity setup is set up such that the atom-cavity setup allows the displaced squeezed vacuum state of the light to interact only with one of transitions of the artificial atom from an excited state to a lower energy level state.

18. The apparatus as claimed in claim 11, wherein the coherent state of light is a laser pulse.

19. The apparatus as claimed in claim 11, wherein the beam splitter used for displacing the photonic state has a high transmission coefficient and a low reflection coefficient.

20. The apparatus as claimed in claim 11, wherein an amount of displacement of the photonic state is proportional to a product of amplitude of the coherent state of light and a reflection coefficient of the beam splitter.
